(19) United States
(12) Patent Application Publication
(10) Pub. No.: US 2013/0200545 A1
(43) Pub. Date: Aug. 8, 2013

(54) Method for the Production of a Ceramic Green Sheet

(71) Applicant: Aloys Josef Foecker, Halver (DE)

(72) Inventor: Aloys Josef Foecker, Halver (DE)

(73) Assignee: EPCOS AG, Muenchen (DE)

(21) Appl. No.: 13/816,201

(22) PCT Filed: Jul. 28, 2011
(86) PCT No.: PCT/EP2011/063044

§ 371 Date: Apr. 22, 2013

(30) Foreign Application Priority Data
Aug. 26, 2010 (DE) 10 2010 035 488.0

(51) Int. Cl. B29C 39/10

(52) U.S. Cl. CPC B29C 39/10
USPC 264/132; 264/272.11

(57) ABSTRACT

In order to produce ceramic green sheets with embedded structures of a functional material, structures of a functional material are first created on a carrier. The same structures are then embedded in a slip layer of a ceramic base material. Nearly plane-parallel green sheets obtained in this manner can easily be further processed to produce ceramic multilayer components.

This patent application is a national phase filing under section 371 of PCT/EP2011/063044, filed Jul. 28, 2011, which claims the priority of German patent application 10 2010 035 488.0, filed Aug. 26, 2010, each of which is incorporated herein by reference in its entirety.

### TECHNICAL FIELD

Embodiments of the invention relate to a method for the production of a ceramic green sheet.

### BACKGROUND

Ceramic components comprise one or more layers of a ceramic material and also two-dimensional or structured conductor structures, usually made of metal, arranged thereon. A ceramic material having purely dielectric properties can serve for insulating the conductor structures. A component produced therefrom may be a ceramic printed circuit board. Ceramic materials having particular electrical properties can be used in conjunction with appropriately applied conductor structures for producing capacitances, inductances and resistance elements.

Relatively complex ceramic components have a multilayer structure and are produced, for example, from laminated stacks of green sheets. The conductor structures are applied in each case to the green sheets or integrated therein. The stack of green sheets is then laminated and sintered.

In the simplest case, the conductor structures can be produced by printing a conductive paste onto the green sheets. As a result of the application of material, however, the green sheets obtain an uneven surface, which creates problems during stacking of the green sheets. Such a stack deforms during lamination when ceramic material flows under pressure into the interstices which remain during stacking. Furthermore, stresses which lead to further instances of deformation during sintering are produced in this way. This has the effect that the conducting structures have to observe a greater tolerance. The accuracy with which the geometries of the conductive structures in particular can be reproduced is thereby reduced. This has the effect that the electrical values of such components are subject to greater fluctuation.

In order to avoid such problems, the ratio between the conductor track thickness and the thickness of the ceramic green sheet is minimized, such that the proportion of deformation in the overall thickness is likewise reduced. Another possibility is to produce depressions in the surface of the ceramic green sheets, these depressions then being filled with metal paste. It is thus possible to obtain a ceramic green sheet with conductive structures which have an even surface. However, this method is associated with a relatively high outlay.

### SUMMARY OF THE INVENTION

In one aspect, the present invention specifies a method for the production of green sheets having integrated structures, which can easily produce green sheets having even surfaces.

What is proposed is a method in which firstly a carrier, a slip of a ceramic base material and a functional material are provided. A structure made of the functional material is then firstly produced on the carrier. A slip layer is then applied to the carrier and over the structure with the slip in such a way that the structure is covered completely by the slip layer and is therefore embedded completely in the slip layer.

The method makes it possible to produce a green sheet having a considerably smaller fluctuation in thickness. The top side of the green sheet, which is arranged closer to the structure of the functional material, is completely even, or has the usual planar topography of the carrier.

Depending on the application method, it is possible for an uneven area to remain on the opposing surface of the slip layer produced, this uneven area tracing the outlines of the geometry of the structure but protruding beyond the rest of the surface of the slip layer to a considerably smaller degree than a structure printed onto the green sheet would do, such that a considerably more even surface is obtained compared to that obtained with the known printing method.

It is also possible, however, to perform the method in such a way that an even surface of the slip layer is formed. To this extent, it may be necessary to even out the surface of the slip layer after it has been applied. This can be effected using a blade, for example, which removes the sheet after it has been applied.

The ceramic base material has any desired composition, but usually has a dielectric character and serves both for insulation purposes and for mechanically stabilizing the later ceramic.

The functional material, by contrast, differs from the ceramic base material in that the structure formed from the functional material produces an electrical function in the component.

A simple combination of base material and functional material are, for example, dielectric and electrical conductor.

An interaction between the functional material or structure made of functional material and the ceramic base material can also lead to an electrical component in which a function beyond electrical insulation is assigned to the ceramic base material.

An electrical functional material and a capacitor ceramic as ceramic base material make it possible to produce capacitors.

In general, it is possible to produce capacitive, inductive and resistive components with electrically conducting structures which are produced from the functional material. The ceramic base material can also have thermistor or posistor properties or comprise a varistor material. PTC (PTC=positive temperature coefficient) or NTC (NTC=negative temperature coefficient) elements or varistors can then be produced therefrom.

The base material can also have magnetic properties and comprise ferrites, for example. Magnets or inductive components can be produced therefrom.

Structures produced from conductive functional material can serve in all cases as electrode layers for the ceramic components to be produced.

A printing method such as, for example, screen printing or stamp printing can be used for producing the structure made of the functional material. To this end, the functional material is provided in the form of a printable, preferably viscous or pasty mass and then printed onto a carrier as a structure. The structure can comprise a desired fine structuring or a relatively large surface area.

A release layer matched both to the adhesive properties of the functional material and to the adhesive properties of the ceramic base material may be applied to the surface of the carrier. The properties of the release layer are adapted in such a way that both the structure made of functional material and the slip layer adhere adequately to the release layer, but at the same time it is possible for the finished green sheet to be detached from the release layer and thus from the carrier without causing damage to the green sheet or the structure embedded therein.

In this context, “green sheet” is understood to mean the combination of slip layer and embedded structure in the state in which all solvent has been removed from the structure and slip layer, i.e., in which the layers of ceramic base material and functional material have been dried.

A further possible way of producing the structure made of the functional material is to apply the functional material to the carrier not in structured form but rather over the whole surface area or over a large surface area as a layer, and only then to structure this layer to form the structure.

For a sinterable green sheet, it is a precondition that all components of the green sheet are sinterable or withstand a sintering process. This relates in particular to the ceramic base material and the functional material.

In a further embodiment, different structures possibly made of different functional material are produced in the method. It is also possible in this respect for different structures to differ in layer thickness or in the height of the applied layer.

It is particularly advantageous for the method to be used for the production of green sheets in which the height of the structure amounts to more than 10% of the overall thickness of the green sheet. The method is also particularly advantageous for producing green sheets having a small thickness of less than 50 μm. Particularly in the case of such thin green sheets, a structure having a thickness amounting to more than 10% of the overall thickness leads to unstable green sheets, which can then be damaged during the lamination or later during the sintering.

Green sheets having a structure embedded according to the invention lead to reduced stresses, and therefore to reduced losses as a result of damaged or unusable products, both during the lamination of stacks of sheets for the production of multilayer ceramics and also during the sintering of said stacks of sheets.

For the production of multilayer components, a plurality of green sheets with and without integrated structures are produced, stacked one on top of another, laminated, sintered and further processed to form ceramic multilayer structures and components. Outer structures, such as metallizations to be applied in particular to the top side or bottom side or else to the side faces of the ceramic multilayer structure, can also be applied after the sintering.

The structures made of functional material are generally different from sheet to sheet in ceramic multilayer components, and therefore in a multilayer structure these can form a three-dimensional structure, for example helical windings of an inductive component which can extend over a plurality of planes of the sheets.

In such a sheet stack/multilayer structure, sheets with and without an embedded structure can also alternate.

To interconnect or electrically connect conductive structures realized in different sheets stacked one on top of another, the green sheets may also be provided with plated-through holes before the stacking and lamination. These can firstly be produced mechanically in the form of holes and punched out, for example, and can then be filled with a conductive mass.

The proposed method is particularly suitable for the production of LTCC (Low Temperature Co-fired Ceramic) or HTCC (High Temperature Co-fired Ceramic) ceramics. Such ceramic multilayer substrates, which themselves already constitute multilayer components or at least can fulfill electrical sub-functions, contain in particular metallic structures made of functional material, where in the case of LTCC the metal can be selected from silver, palladium or platinum. For the production of HTCC ceramics, which differ from the LTCC only in terms of the elevated sintering temperature, another electrode material matched to the higher sintering temperatures is required. HTCC ceramics contain, for example, conductive structures made of copper or tungsten.

### BRIEF DESCRIPTION OF THE DRAWINGS

Hereinbelow, the invention will be explained in more detail with reference to an exemplary embodiment and the associated figures. The figures are shown schematically and not true to scale.

FIG. 1 shows a green sheet according to the invention which is arranged on a carrier and has an embedded structure;

FIGS. 2A to 2D show various method steps for the production of said green sheet;

FIGS. 3A and 3B show two method steps for the production of a multilayer component made of green sheets according to the invention; and

FIGS. 4A and 4B show two method stages for the production of a ceramic multilayer structure which are printed in the known way with conductive structures.

### DETAILED DESCRIPTION OF ILLUSTRATIVE EMBODIMENTS

FIG. 1 shows a green sheet GF produced according to the invention on a carrier TR. A structure ST, which either comprises a ceramic mass or contains metal particles which can be sintered to form conductive structures, is arranged directly on the carrier.

A slip layer SCH is applied over the structure ST, covering the structure ST completely.

The slip layer SCH preferably has a planarized surface, such that the green sheet GF has a constant thickness over the entire surface area.

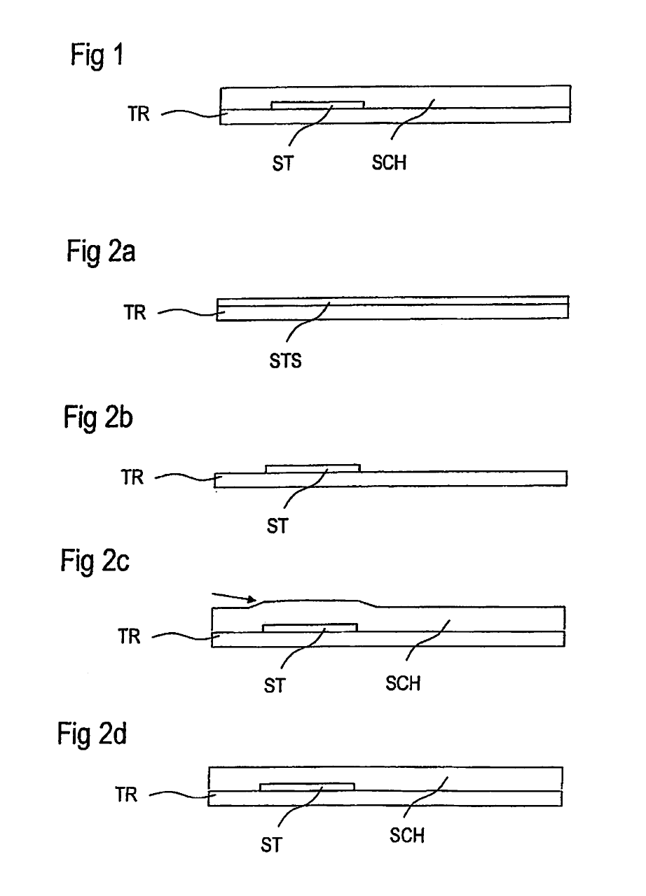

FIGS. 2A to 2D show two different method stages for the production of a green sheet according to the invention. A release layer (not shown) is firstly applied to a carrier TR, which consists of any desired solid, but preferably flexible material such as, for example, a plastic film. This release layer serves to allow for detachable adhesion of the structure which is to be produced thereon and the slip layer. The release layer is selected depending on the materials of the green sheet and then has suitable adhesion and release properties.

A full-area layer STS of a functional material is then applied over the release layer (not shown in the figure), for example in the form of a slip or a paste. Accordingly, the functional material can be laid on or applied by means of sheet casting. Sheet drawing is also a suitable possibility for application. FIG. 2A shows the thus produced layer STS of the functional material.

In the next step, the full-area layer STS is structured to form the desired structure ST. FIG. 2B shows the arrangement on this method stage.

The method stage shown in FIG. 2B can also be achieved, however, by direct production of the structure ST, e.g., by printing on.

In the next step, a slip layer SCH made of a slip of a ceramic base material is applied over the whole surface area, for example, by means of sheet casting or sheet drawing. Depending on the viscosity of the slip and on the application method, it is possible for the structure ST to stand out by a slight elevation on the surface of the slip layer SCH. In this case, it is possible to subsequently even out the structure, for example by removing material by means of a blade. FIG. 2D shows a slip layer with a surface which has been evened out.

With a suitable method, however, the slip layer SCH can also be produced directly with a correspondingly even surface.

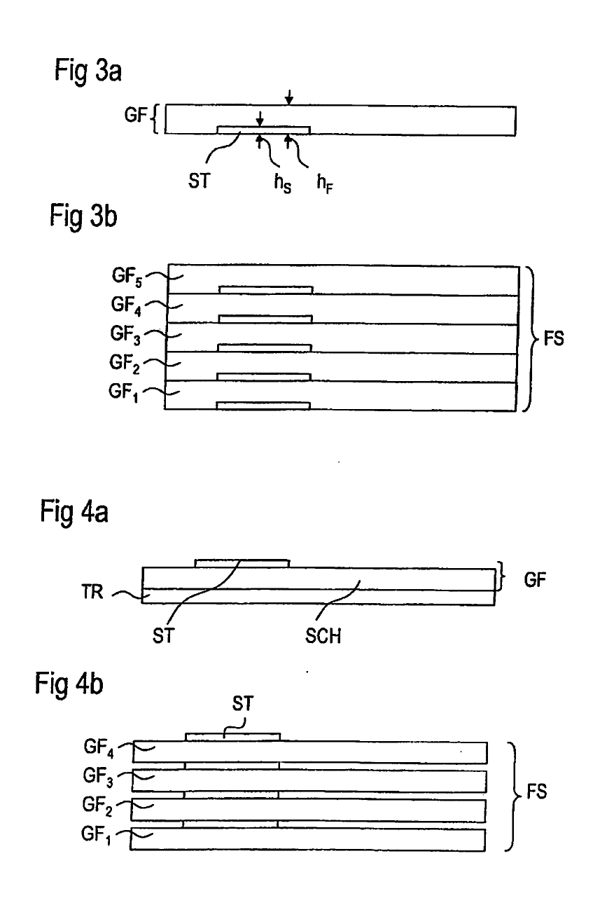

The thus cast or drawn green sheet can then firstly be dried, until the solvent, usually water, has been completely removed. Then, the green sheet GF can be removed from the carrier TR. FIG. 3A shows a corresponding green sheet. As can be seen, the green sheet has two almost completely even surfaces parallel to one another. This plane parallelism makes it possible to increase the proportion of the structure made of functional material in terms of height relative to the overall layer thickness of the green sheet to values of 20% and more, without the green sheet losing stability in the process and without multilayer components produced therefrom showing excessively high loss quotas during lamination and sintering.

If the layer thickness h_{S} of a structure ST made of metallic functional material is assumed to be approximately 10 μm, it is thus possible, for example, to produce green sheets having a layer thickness h_{F} of 50 μm and less, as are required in particular for the production of highly integrated substrates made of LTCC ceramic.

FIG. 3B shows a sheet stack FS, in which here five green sheets GF1 to GF5 are stacked one on top of another. On account of the plane-parallel surfaces, this sheet stack FS has no interstices at all and can therefore be laminated to form a stress-free laminate. Irrespective of stresses which are possibly produced, after lamination such a sheet stack also does not exhibit any warpage of the structures ST produced by the lamination or displacement of the structures in the individual green sheets with respect to one another, which as a whole could lead to structural inaccuracies in the sheet stack.

In comparison to this, FIGS. 4A and 4B show the known production of a sheet stack made of green sheets having structures ST which have been produced by printing a ceramic green sheet. FIG. 4A clearly shows that the structure ST protrudes with its entire layer thickness beyond the surface of the green sheet produced on the carrier TR and generates a corresponding uneven area. As shown in FIG. 4B, when a plurality of green sheets are stacked one on top of another, this leads to interstices, which have to be compensated for during the lamination. This can then have the effect that structures are displaced with respect to one another and therefore no longer sit at the intended position. More disadvantageous still are the stresses which are built up in the process, which stresses arise as a result of tensile loading on the structures and, during later sintering, can lead to damage to the structures or to cracks in the ceramic multilayer structure.

The invention is not limited to the embodiments set forth in the exemplary embodiments. Instead, it is possible to further process green sheets produced not only from the same material but also from different material to form a sheet stack and further to form a multilayer ceramic component.

Different sheets may also alternate in the sheet stack. Green sheets in which no structures ST are embedded may be present.

Plated-through holes, with which conductive structures can be electrically conductively connected to one another beyond a plurality of layers, are also not shown.

With the method according to the invention, it is possible to produce structures of any desired complexity and also structures with fine parts, i.e., structures with a small cross section, without this leading to an increased sensitivity of the structures. Since they are embedded in the layer of the ceramic base material, these are virtually protected during lamination and are not exposed to any additional stress.

Steps of further processing are also not shown, which steps may be necessary for finishing a ceramic multilayer component and in particular relate to the production of conductive structures on the top side and bottom side of the sheet stack. These structures can be applied before or after the sintering. Such structures can also be produced with methods other than thick-film methods, for example by vapor deposition, sputtering and/or electroless deposition or electrodeposition or reinforcement.

1-11. (canceled)

12. A method for producing ceramic green sheets, the method comprising:
forming a structure made of a functional material on a carrier; and
after forming the structure, applying a slip layer of a ceramic base material to the carrier over the structure such that the structure is embedded completely in the slip layer.

13. The method according to claim 12, further comprising planarizing the slip layer after applying the slip layer to the carrier.

14. The method according to claim 13, wherein planarizing the slip layer comprises removing material from the slip layer using a blade.

15. The method according to claim 12, wherein forming the structure comprises printing the structure onto the carrier with a desired pattern.

16. The method according to claim 12, wherein forming the structure comprises:
forming a layer of the functional material over the whole surface area of the carrier; and
patterning the layer to form the structure.

17. The method according to claim 12, wherein the structure comprises a conductive material or a mass that can be sintered to form a conductive material.

18. The method according to claim 12, wherein the structure comprises a ceramic material that differs from the ceramic base material of the slip layer.

19. The method according to claim 12, wherein applying the slip layer comprises covering the structure with the slip layer to such a height of the structure amounts to more than 10% of the overall thickness of the slip layer.

20. The method according to claim 19, wherein applying the slip layer comprises covering the structure with the slip layer so that the slip layer has a height of 50 μm or less.

21. The method according to claim 12, wherein applying the slip layer comprises covering the structure with the slip layer so that the slip layer has a height of 50 μm or less.

22. The method according to claim 12, wherein applying the slip layer comprises applying the slip layer in a sheet casting method.

23. The method according to claim 12, further comprising drying the slip layer to form a green sheet.

24. The method according to claim 23, further comprising detaching the green sheet from the carrier.

25. The method according to claim 24, further comprising stacking the green sheet together with other green sheets to form a sheet stack and laminating the sheet stack to form a multilayer structure.

26. The method according to claim 25, further comprising producing an LTCC or HTCC ceramic from the multilayer structure.

27. The method according to claim 12, further comprising removing the slip layer from the carrier.

28. The method according to claim 27, further comprising applying a release layer to the carrier before forming the structure.

29. A method for producing a ceramic green sheet, the method comprising:
blanket depositing a functional material over a carrier;
patterning the functional material to form a structure over the carrier;
applying a slip layer of a ceramic base material to the carrier over the structure such that the structure is embedded completely in the slip layer;
planarizing the slip layer such that the slip layer with the embedded structure has a substantially constant thickness;
removing the slip layer from the carrier; and
drying the slip layer to form a green sheet.

30. The method according to claim 29, further comprising:
stacking the green sheet together with other green sheets to form a sheet stack; and
laminating the sheet stack to form a multilayer structure.
